(19) United States
(12) Patent Application Publication
(10) Pub. No.: US 2003/0111849 A1
(43) Pub. Date: Jun. 19, 2003

(54) Door lock and door latch connecting device of a vehicle

(76) Inventor: Seung-Min Lee, Ulsan-City (KR)

Correspondence Address: Pennie & Edmonds, LLP, 3300 Hillview Avenue, Palo Alto, CA, 94304, US

(21) Appl. No.: 10/310,316

(22) Filed: Dec. 4, 2002

(30) Foreign Application Priority Data
Dec. 13, 2001 (KR) 2001-78811

(51) Int. Cl. E05B 3/00

(52) U.S. Cl. 292/336.3

(57) ABSTRACT

A door lock and a door latch connecting device of a vehicle in which the portions for releasing the door latch are not exposed to the outside, thereby preventing a vehicular door from being opened by an abnormal method such as inserting a tool into the gap between the door belt and door glass.

### FIELD OF THE INVENTION

The present invention relates to a theft prevention feature and increased assemblage efficiency of a vehicle, and more particularly to a door lock and a door latch connecting device of a vehicle.

### BACKGROUND OF THE INVENTION

In general, once a driver steps out of the vehicle and locks the doors, the doors cannot be opened by mere manipulation of the outside door handles. A key must be used. The typical door lock includes a key cylinder mounted at a housing of the outside handle and a rotating lever secured at a rotor of the key cylinder. The rotating lever is connected to a door latch via a lock rod.

Furthermore, the housing is generally mounted with a rotary arm that is moved downward in response to the pulling of the outside handle. The rotary arm is connected to the door latch via an unlock rod such that when the outside handle is pulled, the unlock rod moves downward to rotate a latch plate at the door latch. A striker mounted at the vehicular body is released from restriction to allow the door to be opened. When this occurs, the force of a torsion spring is restored, allowing the outside handle, the rotary arm, and the unlock rod to return to their original positions. When a user turns the key to rotate the rotating lever and raise the lock rod, the latch plate does not rotate even though the unlock rod is lowered by the internal structure of the door latch. In use, when the door is locked, the door is not opened even though the outside handle is manipulated while the lock rod is lifted.

However, it is a well-known fact that an insertion of a long thin steel plate of about 3-5 cm width into a gap between a door belt and a door glass can be used to push an inner lock rod and release a locked door. Thus, resulting in frequent occurrences of vehicle theft. This abnormal unlocking method is possible because when the long thin steel plate presses the lock rod, the lock rod is lowered to return to its original position where the outside handle operates to lower the unlock rod causing the door to unlock without the use of a key.

In order to prevent the door from being opened in the aforementioned abnormal method, a protective cover has been disclosed in the related art. The protective cover is commonly installed at an upper side of the cylinder for blocking the insertion route of a door lock releasing steel plate. However, the protective cover cannot be formed in a large enough size to completely block the insertion route because of the lay-out of the internal door devices. Thus, this design does not provide sufficient theft protection.

A further current device consists of a clip, which stably connects the lock rod to the rotating lever. The head of the clip is inserted into a hole formed at the rotating lever. The end of the lock rod is formed into the clip such that when the clip is push-fitted into the hole the lock rod can rotate the clip. Furthermore, the lock rod is inserted between the body of the clip and a holder, such that a stable connection is made between the lock rod and the rotating lever.

However, a drawback of using the clip design lies in the assembly work required for the design. The assembly work must be performed in a cramped narrow space in a door, thereby curtailing efficiency of assembly.

### SUMMARY OF THE INVENTION

The present invention provides a door lock and a door latch connecting device of a vehicle adapted to prevent the door lock from being released by a method, such as inserting theft tools like long thin steel plates, and the like into the gap between the door belt and door glass, thereby improving theft-prevention. Further, the present invention expedites the assembly for connecting the door lock and door latch in a manufacturing assembly line.

According to an embodiment of the present invention, the door lock and the door latch connecting device comprises a cable connected at one end thereof to a door latch. An operation force switching means is connected to the other end of the cable for switching a rotary movement of a door lock to a linear movement of the cable. Further, a tube is provided for encompassing the cable for slidable movement and to shut off the cable from the outside. In use, the door lock and the door latch are connected by the cable wrapped by the tube, thereby preventing the locked state of the door lock from being released by a tool such as a long thin steel plate, or the like.

There is another advantage in that it is very easy to connect a connecting device to the door lock thereby improving the assembly process.

### BRIEF DESCRIPTION OF THE DRAWINGS

For fuller understanding of the nature and objects of the invention, reference should be made to the following detailed description taken in conjunction with the accompanying drawings in which:

FIG. 1 is an exploded perspective view of elements comprising a door lock and a door latch connecting device according to an embodiment of the present invention;

FIG. 2 is an enlarged view of each part of the pulley illustrated in FIG. 1;

FIG. 3 is an enlarged view of a cable and the tube in FIG. 1;

FIG. 4 is an enlarged view of the protective cap in FIG. 1;

FIG. 5 is a schematic drawing illustrating an assembled state of the pulley, the cable, and the protective cap to which a key cylinder of the door lock is attached; and

FIG. 6 is a schematic drawing of a spline connecting structure of a pulley and a rotor.

### DETAILED DESCRIPTION OF THE INVENTION

Hereinafter, an embodiment of the present invention will be described in detail with reference to the accompanying drawings.

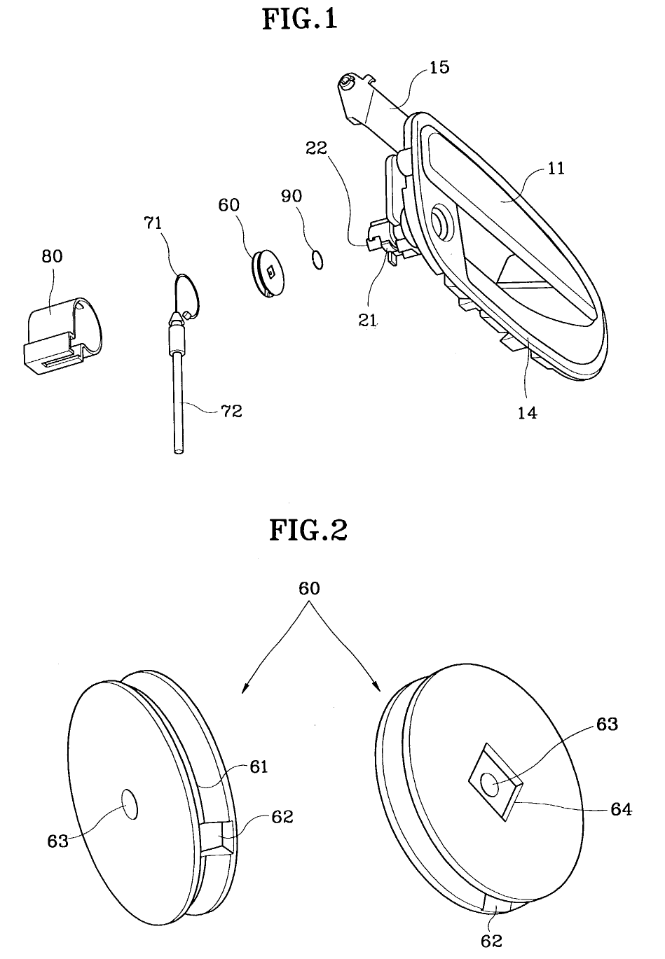

FIG. 1 shows the door lock and the door latch connecting device according to an embodiment of the present invention. The door lock includes a cable 71 connected at one end to a door latch (not shown). Also included is an operation force switching means connected to the other end of the cable 71 for switching the rotary movement of a door lock to a linear movement of the cable 71. Furthermore, a tube 72 is disclosed for encompassing the cable 71 for slidable movement and to shut off the cable 71 from the outside.

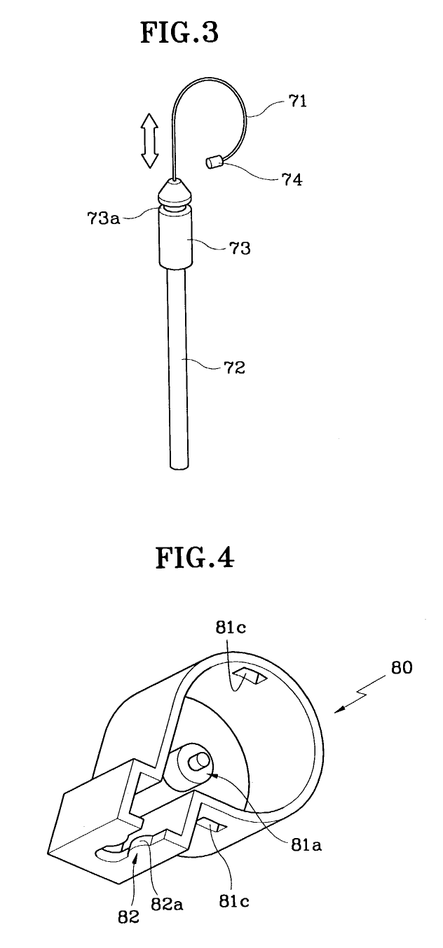

The operation force switching means includes a pulley 60 (FIG. 2) formed with a hitching groove 62 into which a hitching block 74 (FIG. 3) is mounted. The hitching block (FIG. 3) is coupled to the opposite end of the cable 71 from the door latch (not shown). A cable groove 61 (not shown) is provided for receiving and winding the cable 71 during a turning effect from a rotor 22 at the door lock. Also, FIG. 1 shows a protective cap 80 for encompassing an external side of the pulley 60 is provided to prevent the cable 71, wound on the cable groove 61, from being bent and also for encompassing the rotor 22 at the door lock from the outside.

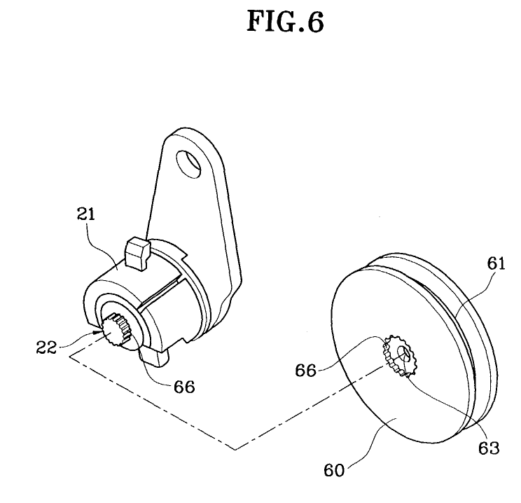

The pulley 60 and the rotor 22 are coupled, such that the turning effect of the rotor 22 can be transmitted to the pulley 60. In use, by way of example and not limitation, a square groove 64 (FIG. 2) is formed at the pulley. The rotor 22 is formed in a matching square pillar shape to allow the rotor 22 (FIG. 1) to be inserted into the square groove 64 (FIG. 2), thereby enabling the transmission of the turning effect of the rotor 22 to the pulley 60. In an alternative embodiment of the invention, the coupled structure of the pulley 60 and the rotor 22 are accomplished by a spline 66 (FIG. 6).

FIG. 4 shows the protective cap 80 integrally formed with a rotary axle 81a for receiving the pulley 60 (FIG. 2). In an embodiment the rotary axle 81a is formed with a stepped portion. When the pulley 60 is inserted into the rotary axle 81a via a central hole 63, the lateral surface of the pulley 60 does not directly contact an inner side of the protective cap 80. Once the pulley 60 (FIG. 2) is inserted into the rotary axle 81a, the inserted state of the pulley 60 is maintained by a snap spring 90, (FIG. 1).

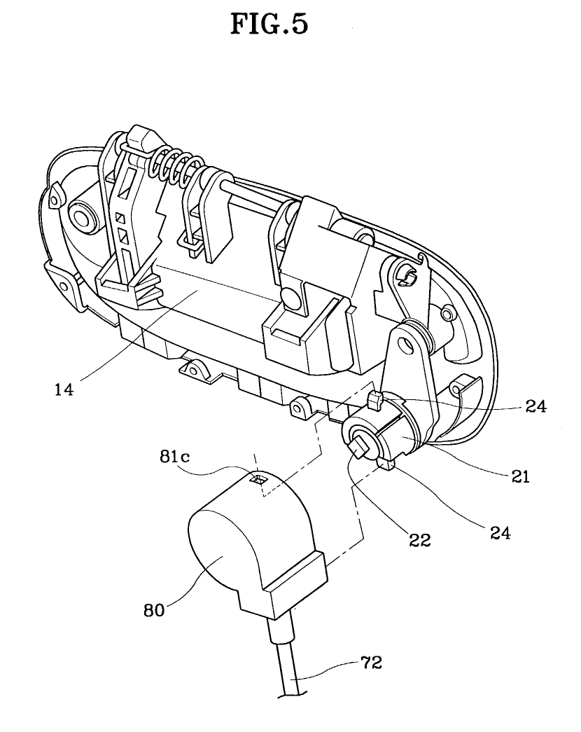

FIG. 5 shows the protective cap 80 formed to be inserted onto an external side of a key cylinder at the door lock in order to encompass the rotor 22 of the door lock. The key cylinder 21 is provided with a plurality of protruding jaws 24 for securing the protective cap 80. The protective cap 80 is formed with insertion holes 81c into which the protruding jaws 24 are inserted. The protective cap 80 can be secured at an external side of the key cylinder 21 at the door lock without using extra tools.

FIG. 3 shows the tube 72 integrally mounted at an end with a bush 73. The bush 73 is formed at a circumferential surface with a fixation groove 73a.

FIG. 4 shows the protective cap 80 is formed with a tube fixation portion 82 to receive the fixation groove 73a of the bush. While the tube fixation portion 82 is formed with a detachment preventing protruder 82a for preventing the bush 73 from being detached from the protective cap 80, the detachment preventing protruder 82a is sized such that the bush 73 can be easily inserted, and the inserted state can be stably maintained.

Hereinafter, a description will be made on how each part is assembled.

The cable 71 (FIG. 1) is wound on the cable groove 61 (FIG. 2) of the pulley 60 and the hitching block 74 (FIG. 3) is press-fitted into the hitching groove 62 (FIG. 2).

Under the above state, the fixation groove 73a of the bush 73 (FIG. 3) mounted at an end of the tube is inserted into the tube fixation portion 82 (FIG. 4) of the protective cap 80. Simultaneously, the pulley 60 (FIG. 1) is inserted into the protective cap 80 such that a central hole 63 (FIG. 2) can be fitted to the rotary axle 81a (FIG. 4).

The pulley 60 is prevented from contacting the internal surface of the protective cap 80 by the stepped rotary axle 81a (FIG. 4). The spaced state, at a predetermined amount, functions to reduce friction during operation.

FIG. 5 shows the pulley 60, the cable 71, and the protective cap 80 all assembled. The plurality of protruding jaws 24 at the key cylinder are inserted into the insertion holes 81c by, for exampe, press-fitting operation of the protective cap 80 toward the key cylinder 21, thereby completing the assembly work. The square pillar-shaped rotor 22 is then fitted into the square groove 64 in order to transmit the turning effect.

In use, when a key is inserted into the key cylinder 21 and turned, the pulley 60 (not shown) is rotated in cooperation with the rotor 22. The cable 71 is wound up by the hitching block 74, FIG. 3, being in contact with the hitching groove 60 (FIG. 2) of the pulley 60.

The cable 71 is connected at one end to the door latch (not shown), such that the winding-up of the cable 71 exercises the unlocking of a door. Thereby, preventing the door from being opened by the simple manipulation of the handle 11 outside of the vehicle.

When a key is inserted and turned while the door is locked as described above, the pulley 60 is rotated to the left to unwind the wound cable 71, which inserts the cable 71 into the tube 72, FIG. 1. Thereby, enabling a user to open the door by the manipulation of the handle 11 outside of the vehicle.

Although the cable 71, FIG. 1) is flexible, the cable 71 is prevented from being bent by restriction of the protective cap 80 and the cable groove 61 at the pulley. The cable 71 is lowered while being disposed inside the tube 72, and the cable 71 pushed out from the bush 73 is not lengthy such that the manipulating power of the cable 71 can be sufficiently transmitted lengthwise.

The tube 72 protects the cable 71, FIG. 1, which is the real actuaor force transmitting medium for locking and unlocking the door. The tube 72 has nothing to do with the locking or unlocking operation of the door lock, such that the door cannot be opened by the conventional abnormal method, thereby reducing car thefts. In use, the tube 72 in the present invention cannot be hitched by a tool having a hooked end to unlatch the latch. Although the tube 72 was hitched and pulled up by such a tool, only a slight deformation results to the tube 72 and the cable 71. Thus, the end of the cable 71 at the door latch (not shown) side cannot be pulled to the inside of the bush 73, thereby preventing the door lock from being unlocked and increasing the vehicle safety from car theft.

The protective cap 80, where the pulley 60 and the cable assembly 70 are mounted, is simple in assembly because only the protective cap 80 needs to be inserted into the key cylinder 21 (FIG. 5). Thus, it is relatively easy to perform a mounting operation.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A door lock and a door latch connecting device of a vehicle, the device comprising:
a cable connected at one end thereof to a door latch;
an operation force switching means connected to the other end of the cable for switching the rotary movement of a door lock to a linear movement of said cable; and
a tube for encompassing said cable for slidable movement to shut off said cable from the outside.

2. The device as defined in claim 1, wherein the operation force switching means comprises
a hitching block mounted at the other end of said cable;
a pulley formed with a hitching groove into which the hitching block is inserted and a cable groove on which said cable is wound for receiving a turning effect from a rotor at the door lock; and
a protective cap for encompassing an external side of the pulley to prevent the cable wound on the cable groove from bending and for encompassing the rotor at said door lock from the outside.

3. The device as defined in claim 2, wherein said pulley and said rotor are connected by spline.

4. The device as defined in claim 2, wherein said pulley and said rotor are coupled by a square pillar and a square groove.

5. The device as defined in claim 2, wherein the protective cap is integrally formed with a rotary axle for said pulley and the rotary axle is formed with a stepped portion so that the lateral surface of said pulley coupled to said rotary axle is made not to directly contact with the inner side of said protective cap.

6. The device as defined in claim 2, wherein said protective cap is so formed as to be inserted into an external side of a key cylinder at said door lock in order to encompass said rotor of said door lock, and the key cylinder is provided with the plurality of protruding jaws for securing said protective cap while said protective cap is formed with insertion holes into which the protruding jaws is inserted.

7. The device as defined in claim 2, wherein the tube is integrally mounted at an end thereof with a bush which is formed with a fixation groove, said protective cap is formed with a tube fixation portion into which the fixation groove is inserted, and the tube fixation portion is formed with a detachment preventing protruder for preventing said bush from being detached.

8. A door lock and a door latch connecting device of a vehicle comprising:
a cable coupled toward a first end with the door latch;
a hitching block coupled toward a second end of said cable;
a pulley configured to receive said hitching block;
a tube for slidably encasing said cable to protect said cable; and
a protective cap configured to receive said pulley and said tube encasing said cable wherein said protective cap protects said cable and said pulley.

9. The device of claim 8, wherein said pulley is configured to receive said cable upon rotation of said pulley.

10. The device of claim 8, wherein said protective cap is configured with a rotary axle for said pulley and a stepped portion such that a lateral surface of said pulley housed within said protective cap does not contact a corresponding lateral surface of the inside of said protective cap.

11. The device of claim 8, wherein said protective cap is configured to couple to an external side of a key cylinder of a door lock thereby encompassing a rotor of said door lock, wherein said protective cap defines a plurality of receivers for jaws that protrude from a key cylinder for securing said protective cap over the key cylinder, and wherein said protective cap is configurted to receive a fixation groove within a bush of said tube.

12. The device of claim 8, wherein said tube is configured to couple with said protective cap such that said tube will remain coupled to said protective cap.
